(19) United States
(12) Patent Application Publication
(10) Pub. No.: US 2014/0207484 A1
(43) Pub. Date: Jul. 24, 2014

(54) DRUG INFORMATION MANAGEMENT DEVICE AND DRUG INFORMATION MANAGEMENT METHOD

(71) Applicant: TERUMO KABUSHIKI KAISHA, Shibuya-ku (JP)

(72) Inventors: Koichiro ASAMA, Kanagawa (JP); Hiroko TOUNOOKA, Kanagawa (JP)

(73) Assignee: TERUMO KABUSHIKI KAISHA, Shibuya-ku (JP)

(21) Appl. No.: 14/222,037

(22) Filed: Mar. 21, 2014

Related U.S. Application Data
(63) Continuation of application No. PCT/JP2012/005989, filed on Sep. 20, 2012.

(30) Foreign Application Priority Data
Sep. 22, 2011 (JP) 2011-207729

(51) Int. Cl. G06F 19/00

(52) U.S. Cl. CPC G06F 19/326
USPC 705/2

(57) ABSTRACT

A medicine information management device and a medicine information management device are disclosed, which can enable CQI of information on a use limitation of a medicine used in medical equipment. The medicine information management device can include a medicine limitation information storage unit configured to: generate and store administration-level-information-associated information on a number of doses of a medicine with respect to a subject of the medicine used in medical equipment; store medicine limitation information that is limitation information for limiting a use of the medicine information of the medicine; store trouble information generated in a case where the medicine is used in the administration level information; generate and store number-of-doses-and-level-associated information on the number and level of troubles; and generate medicine analysis information; and a display unit of a subject side terminal configured to display the medicine analysis information.

### CROSS REFERENCES TO RELATED APPLICATIONS

This application is a continuation of International Application No. PCT/JP2012/005989 filed on Sep. 20, 2012, and claims priority to Japanese Application No. 2011-207729 filed on Sep. 22, 2011, the entire content of both of which is incorporated herein by reference.

### TECHNICAL FIELD

The present invention generally relates to a medicine information management device and a medicine information management method that manages medicine information such as information on use of medicines used in medical equipment, for example, an infusion pump.

### BACKGROUND DISCUSSION

Since medicines (or drugs) used in medical equipment, for example, an infusion pump, used in the hospital or the like can cause problems depending on the usage, there can be a limitation imposed on, for example, the medicine dosage.

When a medicine on which a limitation is imposed is used, a configuration can be adopted in which a limitation (limit) can be defined in advance based on medicine information, and it can be determined whether the usage is within the setting range with reference to the medicine dosage or the like, and in a case where it is outside the setting range, an alert or the like can be sounded, see, for example, U.S. Patent Publication No. 2004/172283.

However, such limitations (limits) on the use of the medicine that was uniformly defined as optimal in a certain period, may not necessarily be correct with the advancement of medicine or the like.

### SUMMARY

A medicine information management device is disclosed, which includes generating and storing administration-level-information-associated information on the number of doses that is actual information on the number of doses of a medicine in multiple items of administration level information with respect to a subject of the medicine used in medical equipment; a medicine limitation information storage unit configured to store medicine limitation information that is limitation information for limiting a use of medicine information of the medicine in association with the administration level information; storing trouble information generated in a case where the medicine is actually used in the administration level information, in association with the medicine information and the administration level information; generating and storing number-of-doses-and-level-associated information on the number and level of troubles based on number information of the trouble information and the administration-level-information-associated information on the number of doses; generating medicine analysis information to show at least the number-of-doses-and-level-associated information on the number and level of troubles and the medicine limitation information, as information associated with the administration- level-information-associated information on the number of doses; and displaying this medicine analysis information on a display unit of a target (or subject) side terminal.

With this configuration, medicine analysis information showing the number-of-doses-and-level-associated information on the number and level of troubles and the medicine limitation information can be generated as information associated with the administration-level-information-associated information on the number of doses, and this medicine analysis information can be displayed on the display unit of the target (or subject) side terminal. For example, since this number-of-doses-and-level-associated information on the number and level of troubles can be generated on the basis of the number information of the trouble information, for example, existence/nonexistence of an alert, and the administration-level-information-associated information on the number of doses, for example, solution transmission number data of each medicine administration rate, it can be, for example, information on alert occurrence frequency or the like with respect to the solution transmission number at each medicine administration rate.

The medicine limitation information is information that defines the range of limitation information, for example, soft limit (an alert is output according to use) and hard limit (an alert is output and operation is stopped according to use) that limits medicine information of a medicine in association with administration level information, for example, the administration rate of the medicine.

The administration-level-information-associated information on the number of doses is information on the number of doses, for example, the solution transmission number of a medicine, of actual medicine information in each administration level information, for example, administration rate data, of medicine information.

For example, the doctor or the like who visually perceives the medicine analysis information shown in the display unit can promptly understand the alert occurrence frequency of each administration rate data and understand the current range of medicine limitation information (soft limit and hard limit) based on the administration rate at the same time.

Further, for example, by simultaneously comparing the alert occurrence frequency of each administration rate data and the ranges of the soft limit and the hard limit or the like, that are medicine limitation information, on the screen of the display unit, a prompt determination whether the medicine limitation information is appropriate can be made.

By using the medicine information management device of the configuration, one can execute CQI (Continuous Quality Improvement) of information on use limitation or the like of a medicine used in medical equipment or the like.

In accordance with an exemplary embodiment, a standard administration level information storage unit can be configured to store standard administration level information that is administration level information serving as a standard of the medicine information is included, and the medication administration standard information can be included in the medicine analysis information as information associated with the administration-level-information-associated information on the number of doses.

According to the configuration, the standard administration level information storage unit can be configured to store the standard administration level information that is the administration level information serving as a standard of the medicine information is included, and the medication administration standard information can be included in the medicine analysis information as information associated with the administration-level-information-associated information on the number of doses.

Since the doctor or the like who visually perceives the medicine analysis information on the display unit can compare the standard administration level information and the administration-level-information-associated information on the number of doses on the screen at the same time, one can promptly determine whether the standard administration level information is appropriate.

In accordance with an exemplary embodiment, medicine limitation change suggestion information that suggests a change of the medicine limitation information can be generated based on the medicine analysis information, and this medicine limitation change suggestion information can be displayed on the display unit of the subject side terminal.

The medicine limitation change suggestion information that suggests a change of the medicine limitation information can be generated based on the medicine analysis information, and this medicine limitation change suggestion information can be displayed on the display unit of the subject side terminal

The doctor or the like who visually perceives the medicine limitation change suggestion information on the display unit can promptly know the change method or the like of the medicine limitation information. Therefore, the medicine limitation information can be updated to include more preferable information, and CQI (Continuous Quality Improvement) of information on use limitation or the like of a medicine used in, for example, medical equipment can be executed.

In accordance with an exemplary embodiment, standard administration level change suggestion information that suggests a change of standard administration level information can be generated based on the medicine analysis information, and this standard administration level change suggestion information can be displayed on the display unit of the subject side terminal.

The standard administration level change suggestion information that suggests a change of the standard administration level information can be generated based on the medicine analysis information, and this standard administration level change suggestion information can be displayed on the display unit of the subject side terminal.

The doctor or the like who visually perceives the standard administration level change suggestion information on the display unit can promptly know, for example, the change method of the standard administration level information.

Therefore, the standard administration level information can be updated to more preferable information, and CQI (Continuous Quality Improvement) of information such as the standard administration level information of a medicine used in medical equipment can be executed.

In accordance with an exemplary embodiment, the medicine limitation information can be changed based on the medicine analysis information.

The medicine limitation information can be changed based on the medicine analysis information. Therefore, the medicine limitation information can be updated to include more preferable information, and CQI (Continuous Quality Improvement) of information on use limitation or the like of a medicine used, for example, in medical equipment can be executed.

In accordance with an exemplary embodiment, standard administration level information can be changed based on the medicine analysis information.

The standard administration level information can be changed based on the medicine analysis information. Therefore, the standard administration level information can be updated to include more preferable information, and CQI (Continuous Quality Improvement) of information of standard administration level information or the like of a medicine used, for example, in medical equipment can be executed.

In accordance with an exemplary embodiment, a medicine information management device is disclosed, the medicine information management device comprising: a medicine limitation information storage unit configured to: generate and store administration-level-information-associated information on a number of doses of a medicine in multiple items of administration level information with respect to a subject of the medicine used in medical equipment; store medicine limitation information that is limitation information for limiting a use of the medicine information of the medicine in association with the administration level information; store trouble information generated in a case where the medicine is used in the administration level information, in association with the medicine information and the administration level information; generate and store number-of-doses-and-level-associated information on the number and level of troubles based on number information of the trouble information and the administration-level-information-associated information on the number of doses; and generate medicine analysis information to show at least the number-of-doses-and-level-associated information on the number and level of troubles and the medicine limitation information as information associated with the administration-level-information-associated information on the number of doses; and a display unit of a subject side terminal configured to display the medicine analysis information.

In accordance with an exemplary embodiment, a medicine information management method is disclosed, which includes: generating and storing administration-level-information-associated information on a number of doses that is actual information on the number of doses of a medicine in multiple items of administration level information with respect to a subject of the medicine used in medical equipment; a medicine limitation information storage unit configured to store medicine limitation information that is limitation information for limiting a use of medicine information of the medicine in association with the administration level information; storing trouble information generated in a case where the medicine information is actually used in the administration level information, in association with the medicine information and the administration level information; generating and storing number-of-doses-and-level-associated information on the number and level of troubles based on number information of the trouble information and the administration-level-information-associated information on the number of doses; generating medicine analysis information to show at least the number-of-doses-and-level-associated information on the number and level of troubles and the medicine limitation information as information associated with the administration-level-information-associated information on the number of doses; and displaying this medicine analysis information on a display unit of a target (or subject) side terminal.

As described above, according to the present disclosure, a medicine information management device and a medicine information management method that enable CQI (Continuous Quality Improvement) of information on the use limitation or the like of medicines used in medical equipment or the like is provided.

### BRIEF DESCRIPTION OF DRAWINGS

FIG. 1 is a schematic view illustrating a pump CQI system according to an exemplary embodiment including, for example, a management server that is a medicine information management device disclosed here.

FIG. 2 is a schematic block diagram illustrating a main configuration of the infusion pump in FIG. 1.

FIG. 3 is a schematic diagram illustrating a main configuration of the management server in FIG. 1.

FIG. 4 is a schematic block diagram illustrating what are included in various storage units in FIG. 3.

FIG. 5 is a schematic flowchart illustrating the main operation of a CQI system according to an exemplary embodiment.

FIG. 6 is another schematic flowchart indicating the main operation of a CQI system according to an exemplary embodiment.

FIG. 7 is a schematic explanatory diagram illustrating pump data stored in the pump data storage unit in FIG. 4.

FIG. 8 is a schematic explanatory diagram illustrating each-medicine soft/hard limit data in each medicine hard/soft limit data storage unit in FIG. 4.

FIG. 9 is a graph illustrating, for example, a medicine library analysis graph that is analysis data per medicine library.

FIG. 10 is a schematic block diagram illustrating the main configuration of a management server according to an exemplary embodiment.

FIG. 11 is a schematic flowchart illustrating the main operation of a management server of a CQI system according to an exemplary embodiment.

### DETAILED DESCRIPTION

Since the embodiments described below are examples of the medical information management device and method disclosed here, technically-preferable aspects are described. However, the scope of the present invention is not limited to these aspects, absent description to the contrary.

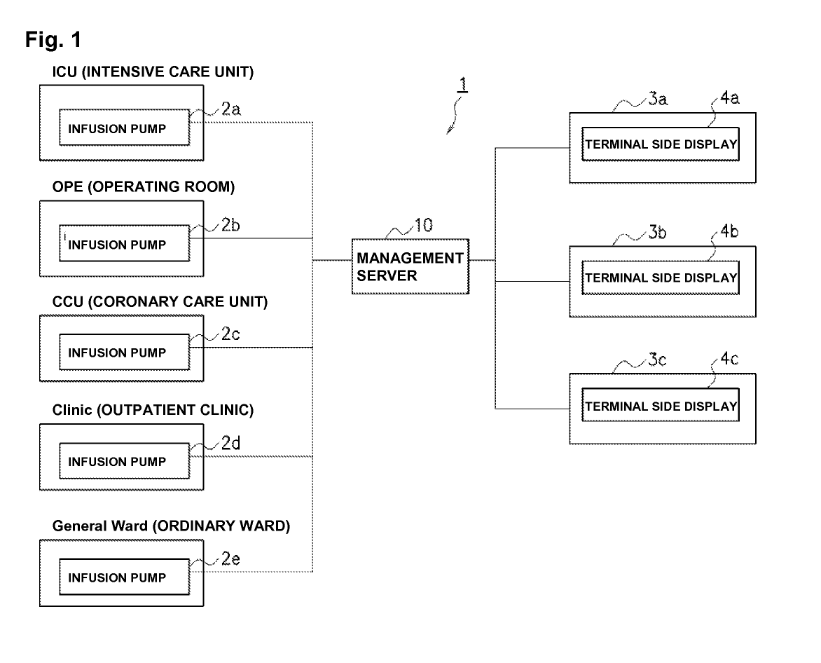

As illustrated in FIG. 1, the pump CQI system 1 includes infusion pumps 2a to 2e arranged, for example, in an ICU (intensive care unit), OPE (operating room), CCU (coronary care unit), Clinic (outpatient clinic) and General Ward (ordinary ward), in a hospital.

The infusion pumps 2a can be medical equipment, which can be used together with an instrument, for example, such as a drip, to accurately administer a medicine or the like to a patient.

Here, an explanation is set forth using the infusion pump 2a as one example of medical equipment to which the disclosure here is applicable. However, the medical equipment may be other equipment such as, for example, a syringe pump.

As illustrated in FIG. 1, these infusion pumps 2a can be connected to the management server 10 such that communication with the server is possible. The infusion pumps 2a can also be connected to medical office terminals 3a to 3c, and arranged in the medial office of doctors and the like, such that communication with the terminals is also possible.

Here, in the medical office terminals 3a, for example, display units in the form of terminal side displays 4a to 4c are shown.

As illustrated in FIG. 1, for ease of explanation, an example is illustrated where the infusion pumps 2 are directly connected to the management server 10. However, the present disclosure is not limited to this, and a configuration, for example, in which each of the infusion pumps 2a is connected to the management server through “software for pump communication (gateway terminal)” that manages each of the infusion pumps 2a can be used. For example, the function of the management server 10 of the present embodiment can be shared between the “software for pump communication (gateway terminal)” and the “management server”.

The pump CQI system 1 of the present embodiment can be a system to promote continuous quality improvement in medical treatment related to the infusion pumps 2a, for example. In accordance with an exemplary embodiment, the system analyzes the use status of medicines or the like from the operation history (pump history) collected from the infusion pumps 2a, and can be configured to improve the method of use of the infusion pumps 2a as well as the content of the medicine library, for example, data of medicine administration limitation.

The infusion pumps 2a, the management server 10 and the medical office terminals 3a illustrated in FIG. 1 have a computer, the computer having, for example, a CPU (Central Processing Unit), RAM (Random Access Memory) and ROM(Read Only Memory), which can be connected through a bus.

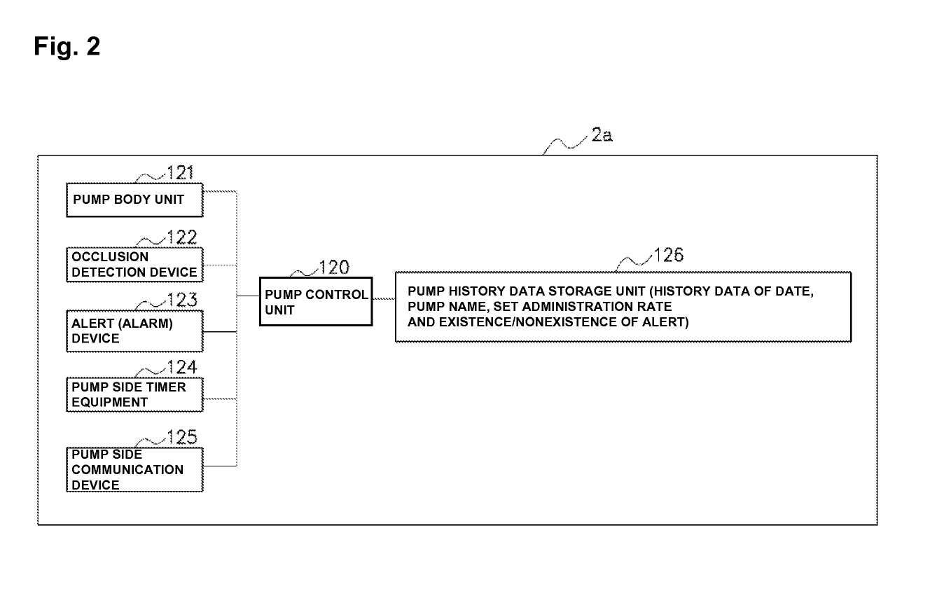

As illustrated in FIG. 2, the infusion pumps 2a can include a pump control unit 120, a pump body unit 121 that performs operation to administer a medicine for drip and the like, for example, a medical solution, to the patient at a predetermined administration rate (one example of administration level information), and an occlusion detection device 122 including a sensor that can detect, for example, in a case where the occlusion or the like occurs while the medical solution in the infusion pumps 2a is administered.

The infusion pumps 2a can include an alert (alarm) device 123 that informs, for example, in a case where the occlusion of the infusion pumps 2a is detected by the occlusion detection device 122, this trouble (one example of trouble information), pump side timer equipment 124 that is a clock or the like, and a pump side communication device 125 by which the infusion pumps 2a and so on perform communication with the management server 10.

The pump body unit 121 can be connected to the pump control unit 120, for example, as illustrated in FIG. 2 and controlled.

Here, although a “pump history data storage unit 126” is also connected to the pump control unit 120 as illustrated in FIG. 2, this configuration is described later in detail.

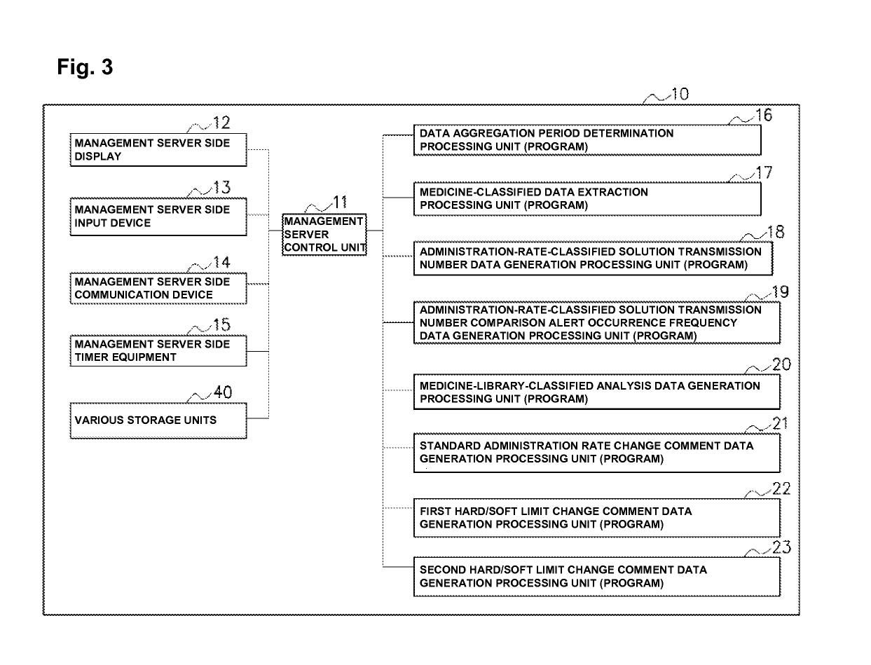

As illustrated in FIG. 3, the management server 10 includes a management server control unit 11, for example, a management server side display 12 that is a display unit to display various kinds of data, a management server side input device 13 that inputs various kinds of data, a management server side communication device 14 by which the management server 10 performs communication with the infusion pumps 2a and, for example, the medical office terminals 3a, and a management server side timer equipment 15 that is a clock or the like.

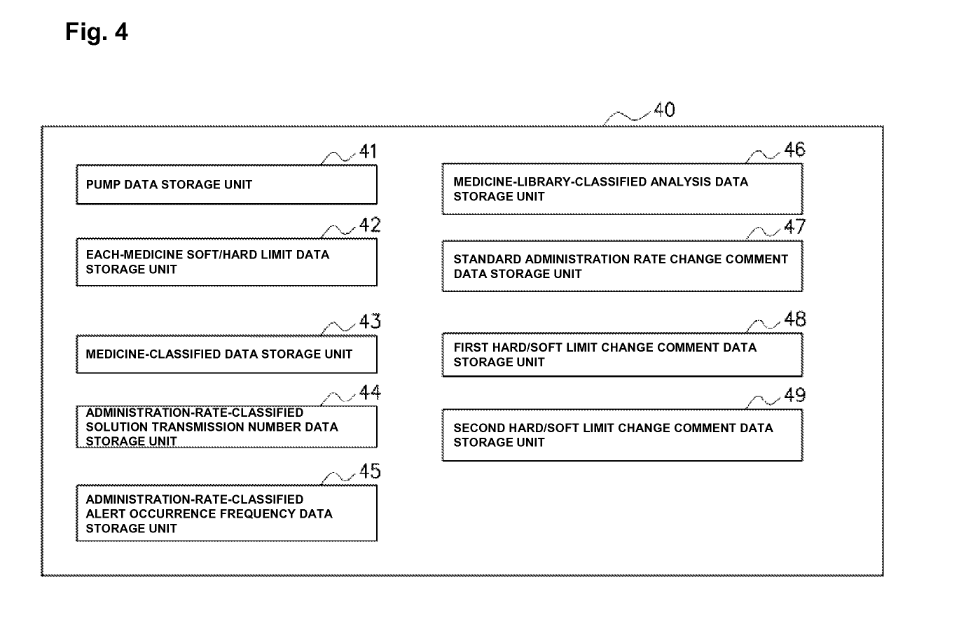

The management server side display 12, for example, can be connected to the management server control unit 11 and controlled. Moreover, as illustrated in FIG. 3, the management server control unit 11 is configured to control various storage units 40 and various processing units (programs). The content of these various storage units 40 and various processing units (programs) are described later in detail. Although FIG. 4 is a schematic block diagram illustrating the content of the various storage units 40 in FIG. 3, the diagram is also described later in detail.

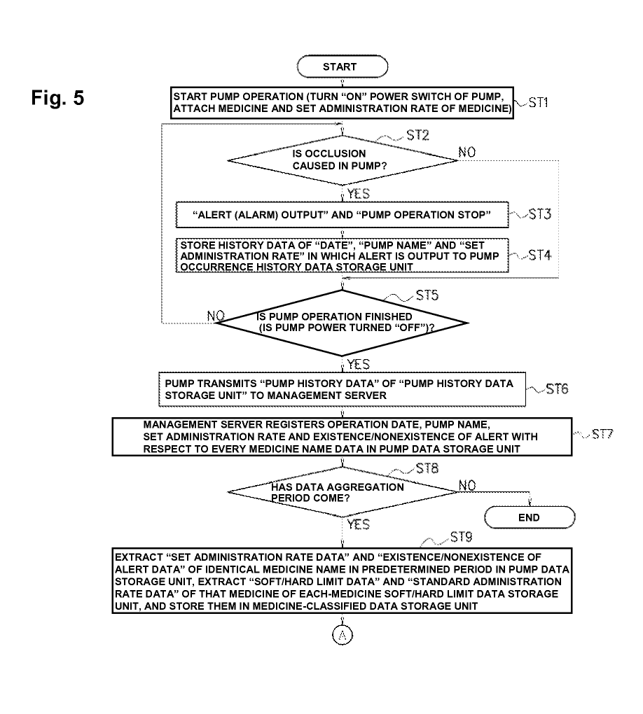

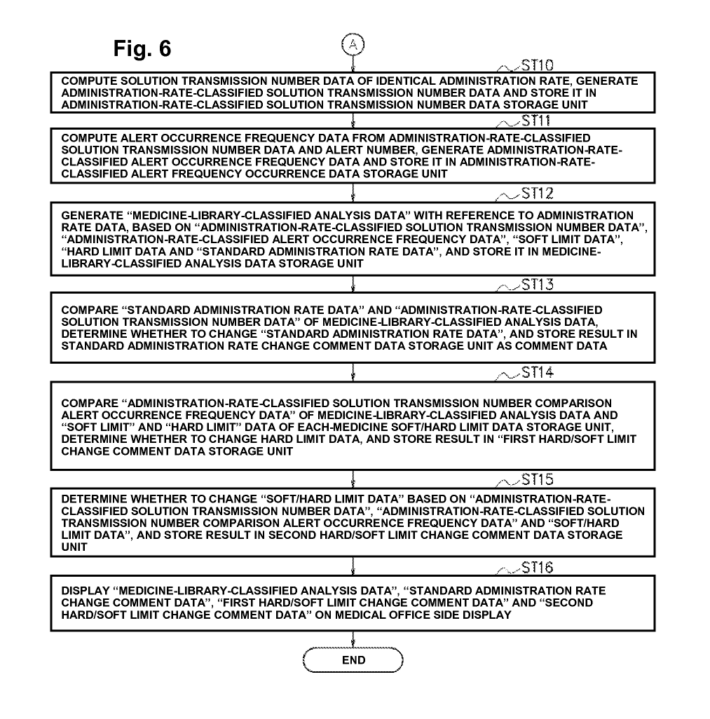

FIGS. 5 and 6 are schematic flowcharts illustrating the main operation of the CQI system 1 according to the present embodiment. In the following, an exemplary embodiment is described according to the flowcharts in FIGS. 5 and 6, and the configurations in FIGS. 1 to 4 are described.

First, in step (hereinafter referred to as “ST”) 1 in FIG. 5, the power switch of the infusion pumps 2a in FIG. 1 enters an “ON” state, and, for example, “Diprivan (registered trademark of AstraZeneca Ltd.)” that is a narcotic is attached to the infusion pumps 2a, and the administration rate of medicine “Diprivan” with respect to the patient is set.

Next, the process proceeds to ST2. In ST2, it is determined whether an occlusion is caused in the infusion pumps 2a.

The occlusion detection device 122 of the infusion pumps 2a illustrated in FIG. 2 operates and determines whether the occlusion state is caused in the infusion pumps 2a.

In a case where the occlusion is caused in the infusion pumps 2a on in ST2, the process proceeds to ST3. In ST3, an alert (alarm) is output and the operation of the infusion pumps 2a is stopped.

Specifically, the alert (alarm) device 123 in FIG. 2 operates to output an alert, and the pump body unit 121 operates to stop the pump operation.

Next, the process proceeds to ST4. In ST4, history data as to “date” on which the alert is output, “pump name” of the infusion pumps 2a, “set administration rate” of the medicine in the infusion pumps 2a, and “existence/nonexistence of the alert”, are stored in the “pump history data storage unit 126” of the infusion pumps 2a and so on in FIG. 2. Moreover, the pump side timer equipment 124 can be referred to the “date”.

Next, the process proceeds to ST5. In ST5, it is determined whether the pump operation has ended, and, in a case where it has, the process proceeds to ST6.

In ST6, the infusion pumps 2a use the pump side communication device 125 in FIG. 2 and transmit the “pump history data” stored in the pump history data storage unit 126 to the management server 10 in FIG. 1.

Next, the process proceeds to ST7. In ST7, the management server 10 having received the data transmitted in ST6 stores the data in a pump data storage unit 41 in FIG. 4.

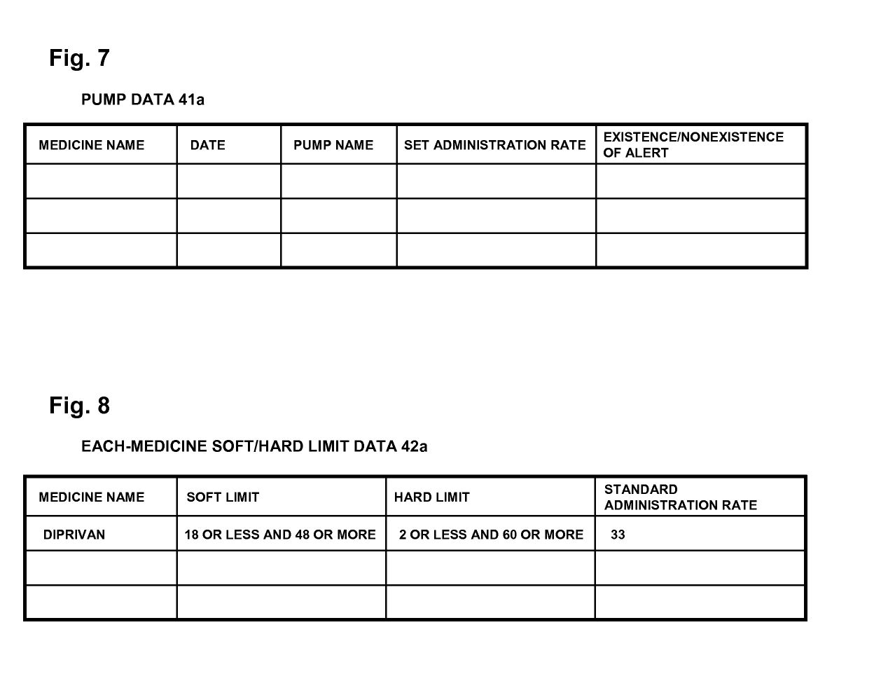

As illustrated in FIG. 7, for example, pieces of data, for example, “medicine name”, “date”, “pump name”, “set administration rate” and “existence/nonexistence of alert” that are medicine information are associated and stored in the pump data 41a.

The “Administration rate” is one example of administration level information and is shown in a unit of, for example, “ml/h”. Moreover, the “alert” is one example of trouble information.

Next, the process proceeds to ST8. In ST8, the management server 10 determines whether a data aggregation period has come. For example, a “data aggregation period determination processing unit (program) 16” in FIG. 3 operates, refers to the management server side timer equipment 15 in FIG. 3 and makes a determination.

In ST8, the process proceeds to ST9 in a case where it is determined that the period has come. In ST9, a medicine-classified data extraction processing unit (program) 17 in FIG. 3 operates and extracts “set administration rate data” and “existence/nonexistence of alert data” of the identical medicine name (for example, “Diprivan”) in a predetermined period in the pump data storage unit 41.

Moreover, the medicine-classified data extraction processing unit (program) 17 extracts “soft/hard limit data” and “standard administration rate” of that medicine “Diprivan” from a “each-medicine soft/hard limit data storage unit 42” in FIG. 4, and stores the “soft/hard limit data” and “standard administration rate” in a “medicine-classified data storage unit 43” in FIG. 4.

As illustrated in FIG. 8, pieces of data, for example, “soft limit”, “hard limit” and “standard administration rate” are mutually associated with respect to every “medicine name” and registered in the “each-medicine soft/hard limit data 42a”.

Here, the “soft limit” denotes limitation information on the administration rate when the medicine name “Diprivan” or the like is used in the infusion pumps 2a, the medicine is not made to be set to the administration rate within the range of the soft limit, and the “alert (alarm)” is output regardless of the existence/nonexistence of actual generation of an occlusion or the like.

Meanwhile, the “hard limit” denotes limitation information on the administration rate when medicine “Diprivan” or the like is used in the infusion pumps 2a, and has a configuration in which, when the medicine is set to the administration rate within the range of the hard limit, “alert (alarm)” is output regardless of the existence/nonexistence of actual generation of an occlusion or the like, and the operation of the infusion pumps 2a is forcibly stopped.

Thus, by setting the range of the “soft limit” or the “hard limit” related to the administration rate different in each medicine beforehand, a configuration can be provided to help prevent an occlusion or the like of the infusion pumps 2a caused by the medicine rate from being generated beforehand.

Moreover, the standard administration rate denotes the administration rate that is the standard of administration of the medicine, and, in the case of medicine “Diprivan” of the present embodiment, it is “33 ml/h” as illustrated in FIG. 8.

In the present exemplary embodiment, as illustrated in FIG. 8, the “soft limit” of the medicine name “Diprivan” is “18 ml/h or less and 48 ml/h or more” and the “hard limit” is “2 ml/h or less and 60 ml/h or more”.

Thus, the “soft limit” and the “hard limit” are one example of the medicine limitation information, and the “each-medicine soft/hard limit data storage unit 42” is one example of the medicine limitation information storage unit.

Moreover, the “standard administration rate” in FIG. 8 is one example of the standard administration level information.

Next, the process proceeds to ST10. In ST10, an “administration-rate-classified solution transmission number data generation processing unit (program) 18” in FIG. 3 operates, computes solution transmission number data of the identical administration rate, generates administration-rate-classified solution transmission number data and stores it in an administration-rate-classified solution transmission number data storage unit 44.

That is, data as to the number of times the medicine is sent at the identical administration rate is generated.

Therefore, the “solution transmission number” is one example of the information on the number of doses, and “administration-rate-classified solution transmission number data” is one example of the “information on the number of doses associated with administration level information”.

Next, the process proceeds to ST11. In ST11, an “administration-rate-classified solution transmission number comparison alert occurrence frequency data generation processing unit (program) 19” in FIG. 3 operates, generates “administration-rate-classified solution transmission number comparison alert occurrence frequency data” from the administration-rate-classified solution transmission number data in the administration-rate-classified solution transmission number data storage unit 44 and the “alert” number of the “existence/nonexistence” of the medicine-classified data storage unit 43, and stores it in an “administration-rate-classified solution alert occurrence frequency data storage unit 45” in FIG. 4.

That is, the data of the “alert occurrence frequency” of each administration rate is generated from the solution transmission number data of each administration rate and the alert frequency data of each administration rate.

Thus, the “administration-rate-classified solution transmission number comparison alert occurrence frequency data” is one example of the “trouble number/level information associated with the number of doses and level”.

Next, the process proceeds to ST12. In ST12, a “medicine-library-classified analysis data generation processing unit (program) 20” in FIG. 3 operates, with reference to administration rate data, for example, generates “medicine-library-classified analysis data” that is medicine analysis information on the basis of “administration-rate-classified solution transmission number data” of the “administration-rate-classified solution transmission number data storage unit 44” in FIG. 4 (for example, data as to the number of times a medicine is sent at the identical administration rate), “administration-rate-classified solution transmission number comparison alert occurrence frequency data” of an “administration-rate-classified alert occurrence frequency data storage unit 45” (for example, data of “alert occurrence frequency” of each administration rate), and the “soft limit data” (for example, 18 ml/h or less and 48 ml/h or more)”, the “hard limit data (2 ml/h or less and 60 ml/h or more)” and “standard administration rate data (33 ml/h)” of the “medicine-classified data storage unit 43”, and stores it in a medicine-library-classified analysis data storage unit 46 in FIG. 4.

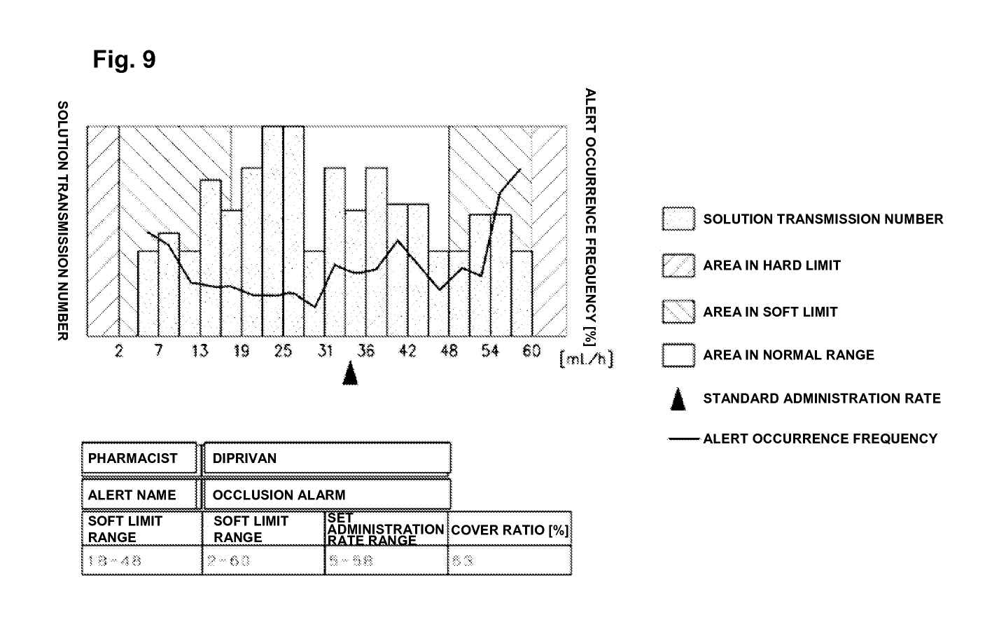

FIG. 9 is a graph illustrating, for example, a “medicine-library analysis graph” that is a medicine-library-classified analysis data. The graph is, for example, a medicine library analysis graph of medicine “Diprivan”.

In the graph, “administration rate data” is arranged in the X axis direction, and the solution transmission number of each administration rate (“administration-rate-classified solution transmission number data”) is illustrated by the bar chart in the Y axis direction.

Moreover, data of “alert occurrence frequency” of each administration rate (“administration-rate-classified solution transmission number comparison alert occurrence frequency data”) is illustrated by the line graph.

Further, the ranges of “soft limit” and “hard limit” are displayed by diagonals.

Next, the process proceeds to ST13. In ST13, a standard administration rate change comment data generation processing unit (program) 21 in FIG. 3 operates, compares the “standard administration rate data” and the “administration-rate-classified solution transmission number data” of the “medicine-library-classified analysis data” in the medicine-library-classified analysis data storage unit 46 in FIG. 4, determines whether to change the “standard administration rate data”, and stores the result in a “standard administration rate change comment data storage unit 47” in FIG. 4 as “standard rate change comment data (one example of standard administration level change suggestion information)”.

For example, referring to the “administration-rate-classified solution transmission number data” in a case where the current “standard administration rate data” is “33 ml/h” as illustrated in FIG. 8, when the number of doses is the largest at an administration rate of “25 ml/h” as illustrated in FIG. 9, in ST13, comment data to change the “standard administration rate data” from “33 ml/h” to “25 ml/h” is stored in the “standard administration rate change comment data storage unit 47” as “standard rate change comment data”.

Next, the process proceeds to ST14. In ST14, a “first hard/soft limit change comment data generation processing unit (program) 22” in FIG. 3 operates, compares the “administration-rate-classified solution transmission number comparison alert occurrence frequency data”, the “soft limit” and the “hard limit” of the “medicine-library-classified analysis data storage unit 46” in FIG. 4, determines whether to change the hard limit data, and stores the result in a “first hard/soft limit change comment data storage unit 48” as “first hard/soft limit change comment data (one example of the medicine limitation change suggestion information)”.

For example, in a case where the “administration-rate-classified solution transmission number comparison alert occurrence frequency data” in the soft limit is greater than a certain level as compared to other administration rates, the data serves as comment data to change the “hard limit data” such that, for example, “54 ml/h” in FIG. 9 which is the administration rate corresponding to that “administration-rate-classified solution transmission number comparison alert occurrence frequency data” is included in the “hard limit data”.

In accordance with an exemplary embodiment, comment data to change and expand the range of the “hard limit” to the left side of FIG. 9 so as to include an administration rate of “54 ml/h” or more in the “hard limit” can be generated and stored in the “first hard/soft limit change comment data storage unit 48”.

This data is one example of the “first hard/soft limit change comment data”.

Next, the process proceeds to ST15. In ST15, a “second hard/soft limit change comment data generation processing unit (program) 23” in FIG. 3 operates, determines whether to change the “hard/soft limit” data on the basis of the “administration-rate-classified solution transmission number data”, the “administration-rate-classified solution transmission number comparison alert occurrence frequency data”, the “soft limit” and the “hard limit” data of the “medicine-library-classified analysis data storage unit 46” in FIG. 4, and stores the result in a “second hard/soft limit change comment data storage unit 49” as “second hard/soft limit change comment data (one example of the medicine limitation change suggestion information)”.

For example, in a case where the solution transmission number (frequency) of the “administration-rate-classified solution transmission number data” is greater than the others, the “administration-rate-classified solution transmission number comparison alert occurrence frequency data” is a low “administration rate”, for example, “13 ml/h” in FIG. 9 and “13 ml/h” is included in the “soft limit” as illustrated in FIG. 9, comment data is generated to change the “soft limit” such that the “13 ml/h” is included in an “area within a normal range” instead of the soft limit. Specifically, it is comment data to change and reduce the range of the soft limit in FIG. 9 in the left direction in FIG. 9.

This data is one example of the “second hard/soft limit change comment data”.

Next, the process proceeds to ST16. In ST16, the management server 10 transmits the following data, for example to the medical office terminals 3a in FIG. 1:

1) “Medicine-library-classified analysis data (for example, data in FIG. 9)” in the medicine-library-classified analysis data storage unit 45 in FIG. 4;

2) “Standard administration rate change comment data” of the standard administration rate change comment data storage unit 47 (for example, comment data to change “standard administration rate data” from “33 ml/h” to “25 ml/h”);

3) “First hard/soft limit change comment data” in the first hard/soft limit change comment data storage unit 48 (for example, comment data to change and expand the range of the “hard limit” to the left side in FIG. 9 such that an administration rate of “54 ml/h”) or more is included in the “hard limit”); and

4) “Second hard/soft limit change comment data” in the second hard/soft limit change comment data storage unit 49 (for example, comment data to change “soft limit” such that “13 ml/h” is included in the “area in the normal range” instead of the soft limit.

Further, for example, the medical office terminals 3a having received these items of data display these items of data on, for example, the terminal side displays 4a of the terminals.

Therefore, by visually perceiving the “medicine-library-classified analysis data” which is illustrated in FIG. 9 and displayed, for example, on the terminal side displays 4a, the doctor or the like in the medical office can promptly understand the alert occurrence frequency of each administration rate and, at the same time, immediately understand whether the ranges of the “soft limit” and the “hard limit” based on the administration rate are appropriate.

Moreover, the “standard administration rate change comment data” can also, for example, be displayed on the terminal side displays 4a together with the “medicine-library-classified analysis data”.

Therefore, since the doctor or the like can promptly know the necessity of the change in the “standard administration rate data” and a specific change method based on the “standard administration rate change comment data”, the doctor or the like can appropriately perform the change.

Moreover, the “first hard/soft limit change comment data” and the “second hard/soft limit change comment data” can be displayed on the terminal side displays 4a together with the “medicine-library-classified analysis data”.

Therefore, since the doctor or the like can know the change in the ranges of the “soft limit” and the “hard limit”, and the change method, the doctor or the like can appropriately perform the change.

As described above, according to the present example embodiment, by using the management server 10, CQI of information on use limitation or the like of the “soft limit” and the “hard limit” or the like of the medicine used in the infusion pumps 2a can be achieved.

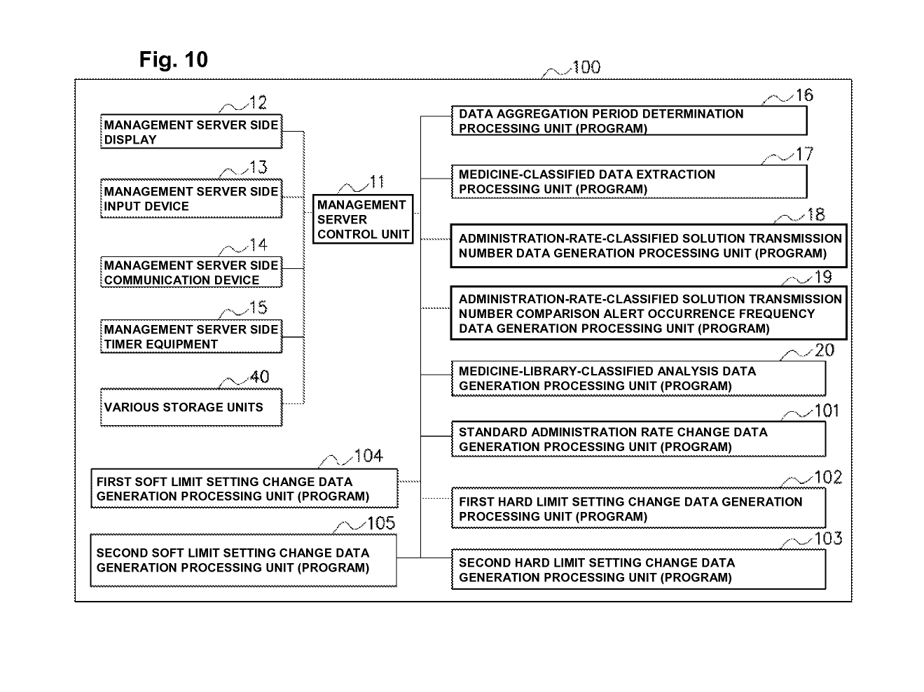

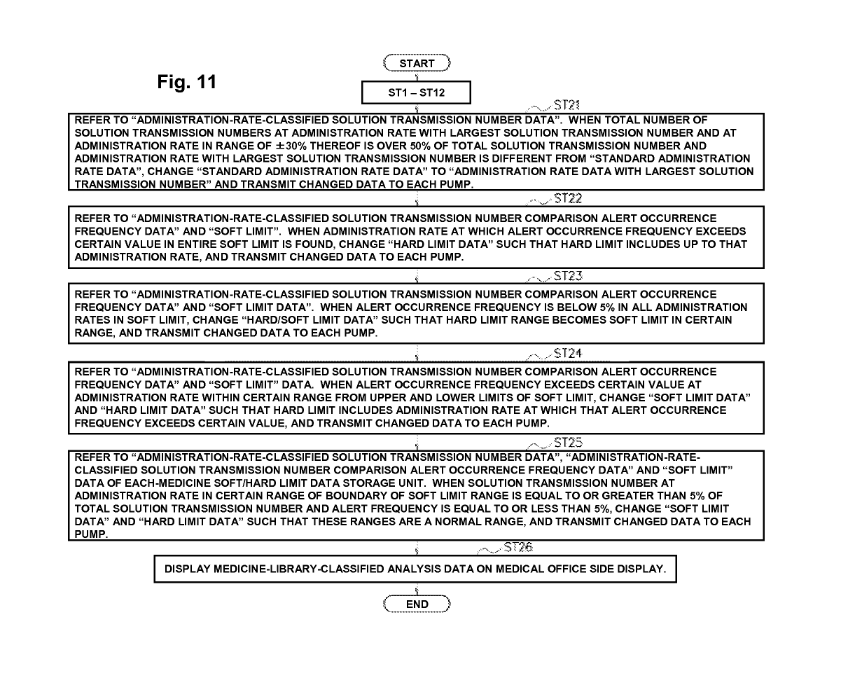

FIG. 10 is a schematic block diagram illustrating the main configuration of a management server 100 according to an exemplary embodiment of the present invention.

Since the present embodiment has many common parts with the configuration of the embodiment described above, common features are identified by the same reference numerals, and a detailed explanation of such features is not repeated. The description which follows thus focuses primarily on the differences in this embodiment relative to the embodiment described above.

FIG. 11 is a schematic flowchart illustrating the main operation of the management server 100 of the CQI system according to the present exemplary embodiment.

First, in the present exemplary embodiment, similar to the exemplary embodiment described above, steps ST1 to ST12 are executed and “medicine-library-classified analysis data” can be generated and stored.

Next, the process proceeds to ST21. In ST21, a “standard administration rate change data generation processing unit (program) 101” in FIG. 10 operates, refers to the “medicine-library-classified analysis data” in FIG. 4, and, in a case where the total number of the solution transmission numbers at the administration rate with the largest solution transmission number and at the administration rate in a range of ±30% thereof is over 50% of the total solution transmission number and the administration rate with the largest solution transmission number is different from “standard administration rate data” of the “medicine-library-classified analysis data storage unit 46”, changes “standard administration rate data” of “medicine-library-classified analysis data” and an “each-medicine soft/hard limit data storage unit 42” to the “administration rate data with the largest solution transmission number”.

Moreover, the administration rate change data generation processing unit (program) 101 can transmits this changed data to each of the infusion pumps 2a and so on in FIG. 1, for example.

By this means, since the “standard administration rate data” of the medicine library data is always automatically updated as appropriate data, a CQI process of medicine information used in the infusion pumps 2a can be executed, for example.

Next, the process proceeds to ST22. In ST22, a “first hard limit setting change data generation processing unit (program) 102” in FIG. 10 operates, refers to “administration-rate-classified solution transmission number comparison alert occurrence frequency data” and “soft limit data” of the “medicine-library-classified analysis data”, and, in a case where there is an “administration rate” at which the alert occurrence frequency exceeds a certain value in the entire administration rate in the soft limit, changes the “hard limit data” of the “medicine-library-classified analysis data” and the “each-medicine soft/hard limit data storage unit 42” such that the “hard limit” includes up to that administration rate.

Moreover, the first hard limit setting change data generation processing unit (program) 102 can transmits the changed data to each of the infusion pumps 2a in FIG. 1, for example.

Next, the process proceeds to ST23. In ST23, a “second hard limit setting change data generation processing unit (program) 103” in FIG. 10 operates, refers to the “administration-rate-classified solution transmission number comparison alert occurrence frequency data” and the “soft limit data” of the “medicine-library-classified analysis data”, and, when the alert occurrence frequency is below 5% in all administration rates in the soft limit, changes the “hard limit data” and the “soft limit data” of the “medicine-library-classified analysis data” and the “each-medicine soft/hard limit data storage unit 42” so as to change the hard limit range to the soft limit range in a certain range (for example, expand the soft limit range).

Moreover, the second hard limit setting change data generation processing unit (program) 103 can transmits the changed data to each of the infusion pumps 2a in FIG. 1, for example.

Next, the process proceeds to ST24. In ST24, a “first soft limit setting change data generation processing unit (program) 104” in FIG. 10 operates, refers to the “administration-rate-classified solution transmission number comparison alert occurrence frequency data” and the “soft limit data” of the “medicine-library-classified analysis data”, and, in a case where the alert occurrence frequency exceeds a certain value at the administration rate within a certain range from the upper and lower limits of the soft limit, changes the “hard limit data” and the “soft limit data” of the “medicine-library-classified analysis data” and the “each-medicine soft/hard limit data storage unit 42” such that the “hard limit” includes the administration rate at which the alert occurrence frequency exceeds the certain value.

Moreover, the first soft limit setting change data generation processing unit (program) 104 can transmit the changed data to each of the infusion pumps 2a in FIG. 1, for example.

Next, the process proceeds to ST25. In ST25, a “second soft the limit setting change data generation processing unit (program) 105” in FIG. 10 operates, refers to “administration-rate-classified solution transmission number data”, “administration-rate-classified solution transmission number comparison alert occurrence frequency data” and the “soft limit data” of the “medicine-library-classified analysis data”, and, in a case where the solution transmission number at the administration rate in a certain range of the boundary of the soft limit range is equal to or greater than 5% of the total solution transmission number and the alert frequency is equal to or less than 5%, changes the “hard limit data” and the “soft limit data” of the “medicine-library-classified analysis data” and the “each-medicine soft/hard limit data storage unit 42” such that these ranges are normal ranges.

Moreover, the second soft the limit setting change data generation processing unit (program) 105 can transmit the changed data to each of the infusion pumps 2a in FIG. 1, for example.

Thus, in ST22 to ST25, since the ranges of the “hard limit data” and the “soft limit data” are automatically changed to appropriate ranges on the basis of data, such as an actual alarm, an effective CQI process of medicine information such as the “hard limit data” and the “soft limit data” used, for example, in the infusion pumps 2a can be effectively executed.

Next, the process proceeds to ST26. In ST26, the management server 10 can transmit the “medicine-library-classified analysis data (for example, data in FIG. 9)” in the medicine-library-classified analysis data storage unit 46 in FIG. 4 to the medical office terminals 3a in FIG. 1, for example.

Further, the medical office terminals 3a and so on having received these items of data display these items of data on terminal side displays 4a of the terminals.

Therefore, by visually perceiving the “medicine-library-classified analysis data” which is illustrated in FIG. 9 and displayed on the terminal side displays 4a, the doctor or the like in the medical office can promptly understand the alert occurrence frequency of each administration rate.

Moreover, in the present embodiment, the ranges of the “soft limit” and the “hard limit” can be automatically corrected and changed in an appropriate manner.

Therefore, the doctor or the like does not have to voluntarily correct the ranges of the “soft limit” and the “hard limit”, and a rather extremely easy-to-use system is provided.

The detailed description above describes a medicine information management device and medicine information management method disclosed by way of example. The invention is not limited, however, to the precise embodiment and variations described. Various changes, modifications and equivalents can effected by one skilled in the art without departing from the spirit and scope of the invention as defined in the accompanying claims. It is expressly intended that all such changes, modifications and equivalents which fall within the scope of the claims are embraced by the claims.

What is claimed is:

1. A medicine information management device, the medicine information management device comprising:
a medicine limitation information storage unit configured to:
generate and store administration-level-information-associated information on a number of doses of a medicine in multiple items of administration level information with respect to a subject of the medicine used in medical equipment;
store medicine limitation information that is limitation information for limiting a use of the medicine information of the medicine in association with the administration level information;
store trouble information generated in a case where the medicine is used in the administration level information, in association with the medicine information and the administration level information;
generate and store number-of-doses-and-level-associated information on the number and level of troubles based on number information of the trouble information and the administration-level-information-associated information on the number of doses; and
generate medicine analysis information to show at least the number-of-doses-and-level-associated information on the number and level of troubles and the medicine limitation information as information associated with the administration-level-information-associated information on the number of doses; and
a display unit of a subject side terminal configured to display the medicine analysis information.

2. The medicine information management device according to claim 1, further comprising:
a standard administration level information storage unit configured to store standard administration level information that is administration level information serving as a standard of the medicine information, wherein the standard administration level information is included in the medicine analysis information as information associated with the administration-level-information-associated information on the number of doses.

3. The medicine information management device according to claim 1, wherein medicine limitation change suggestion information that suggests a change of the medicine limitation information is generated based on the medicine analysis information, and the medicine limitation change suggestion information is displayed on the display unit of the subject side terminal.

4. The medicine information management device according to claim 2, wherein the medicine limitation change suggestion information that suggests a change of the medicine limitation information is generated based on the medicine analysis information, and the medicine limitation change suggestion information is displayed on the display unit of the subject side terminal.

5. The medicine information management device according to claim 1, wherein standard administration level change suggestion information that suggests a change of the standard administration level information is generated based on the medicine analysis information, and this standard administration level change suggestion information is displayed on the display unit of the subject side terminal.

6. The medicine information management device according to claim 2, wherein standard administration level change suggestion information that suggests a change of the standard administration level information is generated based on the medicine analysis information, and this standard administration level change suggestion information is displayed on the display unit of the subject side terminal.

7. The medicine information management device according to claim 3, wherein standard administration level change suggestion information that suggests a change of the standard administration level information is generated based on the medicine analysis information, and this standard administration level change suggestion information is displayed on the display unit of the subject side terminal.

8. The medicine information management device according to claim 4, wherein standard administration level change suggestion information that suggests a change of the standard administration level information is generated based on the medicine analysis information, and this standard administration level change suggestion information is displayed on the display unit of the subject side terminal.

9. The medicine information management device according to claim 1, wherein the medicine limitation information is changed based on the medicine analysis information.

10. The medicine information management device according to claim 2, wherein the medicine limitation information is changed based on the medicine analysis information.

11. The medicine information management device according to claim 3, wherein the medicine limitation information is changed based on the medicine analysis information.

12. The medicine information management device according to claim 4, wherein the medicine limitation information is changed based on the medicine analysis information.

13. The medicine information management device according to claim 5, wherein the medicine limitation information is changed based on the medicine analysis information.

14. The medicine information management device according to claim 6, wherein the medicine limitation information is changed based on the medicine analysis information.

15. The medicine information management device according to claim 7, wherein the medicine limitation information is changed based on the medicine analysis information.

16. The medicine information management device according to claim 8, wherein the medicine limitation information is changed based on the medicine analysis information.

17. The medicine information management device according to claim 1, wherein the standard administration level information is changed based on the medicine analysis information.

18. A medicine information management method, the medicine information management method comprising:
generating and storing administration-level-information-associated information on a number of doses that is actual information on the number of doses of a medicine in multiple items of administration level information with respect to a subject of the medicine used in medical equipment;
storing medicine limitation information that is limitation information for limiting a use of medicine information of the medicine in association with the administration level information;
storing trouble information generated in a case where the medicine information is actually used in the administration level information, in association with the medicine information and the administration level information;
generating and storing number-of-doses-and-level-associated information on the number and level of troubles based on number information of the trouble information and the administration-level-information-associated information on the number of doses;
generating medicine analysis information to show at least the number-of-doses-and-level-associated information on the number and level of troubles and the medicine limitation information as information associated with the administration-level-information-associated information on the number of doses; and
displaying the medicine analysis information on a display unit of a subject side terminal.
